(19) United States
(12) Patent Application Publication
(10) Pub. No.: US 2015/0363882 A1
(43) Pub. Date: Dec. 17, 2015

(54) SYSTEMS, METHODS, AND COMPUTER PRODUCTS FOR AN ADJUSTABLE GUARANTEED BENEFIT RETIREMENT PLAN

(71) Applicant: Weeks Retirement Solutions, LLC, Atlanta, GA (US)

(72) Inventor: Clark Weeks, Atlanta, GA (US)

(21) Appl. No.: 14/739,867

(22) Filed: Jun. 15, 2015

Related U.S. Application Data
(60) Provisional application No. 62/011,801, filed on Jun. 13, 2014.

(51) Int. Cl. G06Q 40/06

(52) U.S. Cl. CPC G06Q 40/06

(57) ABSTRACT

Technologies are described herein for providing a funding-adjusted guaranteed benefit in a retirement plan. In some aspects, the employer may make a commitment to contribute a fixed percentage of payroll each payroll cycle. An actuarial basis may be used to determine liabilities in the plan. An actuary, or other suitable technology, may determine the benefit which is the funded portion using the fixed percentage. The funded portion may be reduced by a margin. In some examples, a retirement plan executed according to various technologies described herein can guarantee a benefit of half of the funded portion as reduced by a margin. In the event the plan is overfunded by 100% or more, in some examples, the plan may pay double the guaranteed benefit.

### CROSS REFERENCE TO RELATED APPLICATIONS

This application claims the benefit of U.S. Provisional Application No. 62/011,801 filed Jun. 13, 2014, entitled “Systems, Methods, and Computer Products for an Adjustable Guaranteed Benefit Retirement Plan,” which is incorporated by reference herein in its entirety.

### BACKGROUND

Many governments and employers are unable to afford the cost uncertainty of defined benefit plans, such as a defined benefit pension plan, in which the employer promises a specified monthly benefit. The popular solution is a defined contribution plan in which the employer, employee or both make contributions on a regular basis. In defined contribution plans, future benefits fluctuate on the basis of investment earnings. The issue with this is that defined contribution plans do not produce retirement income security. Thus, it is desirable to have a plan that can address cost uncertainty issues, while increasing the probability of producing a stable monthly check for the worker.

It is with respect to these and other considerations that the disclosure made herein is presented.

### SUMMARY

Technologies are described herein for providing an adjustable guaranteed benefit retirement plan. In some examples, a retirement plan, sometimes an employer or government provided plan, is established whereby a minimum benefit is guaranteed based on a minimum funding of the benefit plan. In some examples, the minimum funding amount is greater than the guaranteed benefit, a condition called “overfunding.” In some implementations, the ratio of the minimum benefit to the overfunding percentage is based on a risk profile, whereas the minimum overfunding represents a highest risk associated with the guaranteed benefit.

The guaranteed benefit may be the minimum benefit. In some implementations, as the overfunding percentage increases above the minimum funding level established, the benefit is increased (e.g., a percentage of the increase). In a similar manner, as the overfunding percentage decreases, the increased benefit may be decreased a percentage of the decrease. In some implementations, the overfunding percentage and accompanying benefit adjustments provide for double or more of the benefit over the guaranteed minimum benefit. An overfunding percentage above a certain amount may also reduce the contribution required, in some examples.

In some aspects, the employer may make a commitment to contribute a fixed percentage of payroll each payroll cycle. An actuarial basis may be used to determine liabilities (risks) in the plan. An actuary, or other suitable technology, may determine the benefit which is the funded portion using the fixed percentage. The funded portion may be reduced by a margin. In some examples, a retirement plan executed according to various technologies described herein can guarantee a benefit of half of the funded portion as reduced by a margin. Various aspects of the plan may set a fiduciary standard for investment returns.

In some examples, a failure to meet this fiduciary standard is the only way an employer may be forced to contribute additional assets, sometimes up to a high 90's percentile. A retirement plan executed according to various technologies described herein defines the method to value the liability for the plan with a mechanism to update the assumptions (as described below) as needed. In the event the plan is overfunded by 100% or more, in some examples, the plan may pay double the guaranteed benefit. In some cases, no additional payments may be made when the funded status declines to a specified surplus, such as a 75% surplus.

In some examples, in the event the plan is overfunded by 150% or more (or some other overfunding level), an entity implementing the plan may either enhance benefits or reduce contributions, or both. Funded status may be determined periodically, and benefit payments may be modified periodically. Other time frames may also be used. Employer contribution might be a mandated amount. It should be understood that any percentages or amounts described herein are for purposes of illustration only and are not an attempt to limit the scope of the presently disclosed subject matter to those amounts or percentages.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram showing one illustrative operating environment that may be used to implement various embodiments described herein.

FIG. 2 is a flow diagram showing aspects of a method for providing a funding-adjusted guaranteed benefit in a retirement plan, in accordance with some embodiments.

FIG. 3 is a diagram showing aspects of adjusting a payment level, in accordance with some embodiments.

FIG. 4 is a computer architecture diagram illustrating an illustrative computer hardware and software architecture for a computing system capable of implementing aspects presented herein.

### DETAILED DESCRIPTION

Embodiments of the disclosure presented herein encompass methods, systems, apparatuses, and computer-readable media for providing a funding-adjusted guaranteed benefit in a retirement plan. In some conventional retirement plans, the retirement plan is modified based on the contribution. A fixed benefit is determined, and thereafter, the liability is measured. A measurement of the liability determines the contribution amount. The process is repeated to adjust the plan. According to various aspects disclosed herein, a retirement plan is modified based on benefit. A fixed contribution is determined, and thereafter the liability is measured. The benefit is determined and the plan is modified.

Referring now to the drawings, in which like numerals represent like elements throughout the several figures, aspects of an exemplary operating environment and the implementations provided herein will be described.

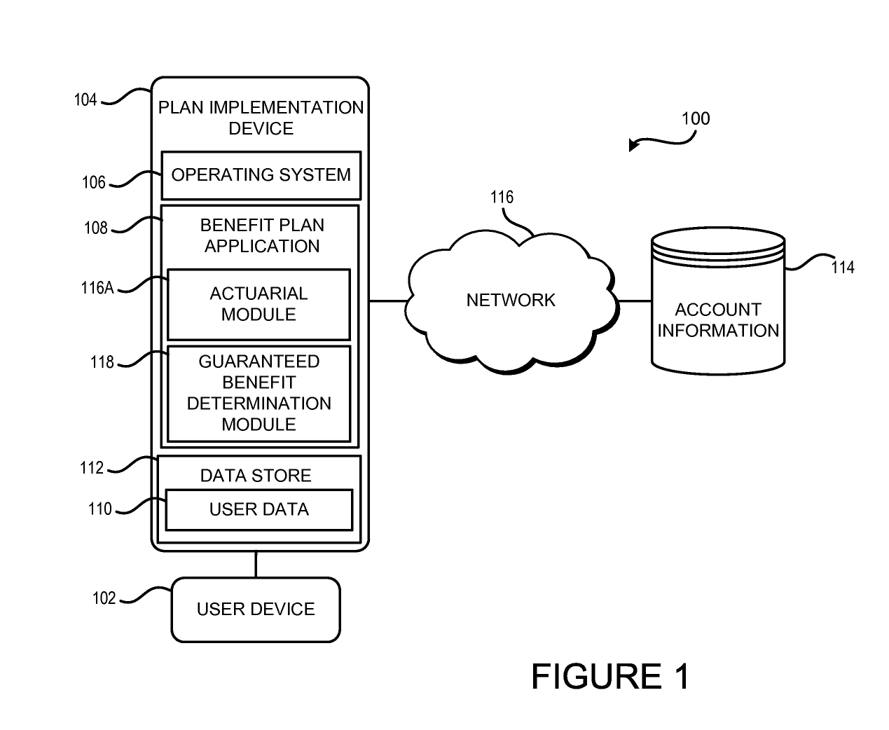

FIG. 1 and the following discussion are intended to provide a brief, general description of a suitable operating environment 100 in which embodiments presented herein may be implemented. It should be appreciated that not all components shown in the operating environment 100, and described in each embodiment presented herein, may be required to practice the presently disclosed subject matter.

The operating environment 100 shown in FIG. 1 includes a user device 102 and a plan implementation device 104. According to various configurations, the functionality of the user device 102 and/or the plan implementation device 104 can be provided by a personal computer (“PC”) such as a desktop, tablet, or laptop computer system. In some other configurations, the functionality of the user device 102 and/or the plan implementation device 104 can be provided by other types of computing systems or devices including, but not limited to, a handheld computer, a netbook computer, an embedded computer system, a mobile telephone, a smart phone, or another type of computing device.

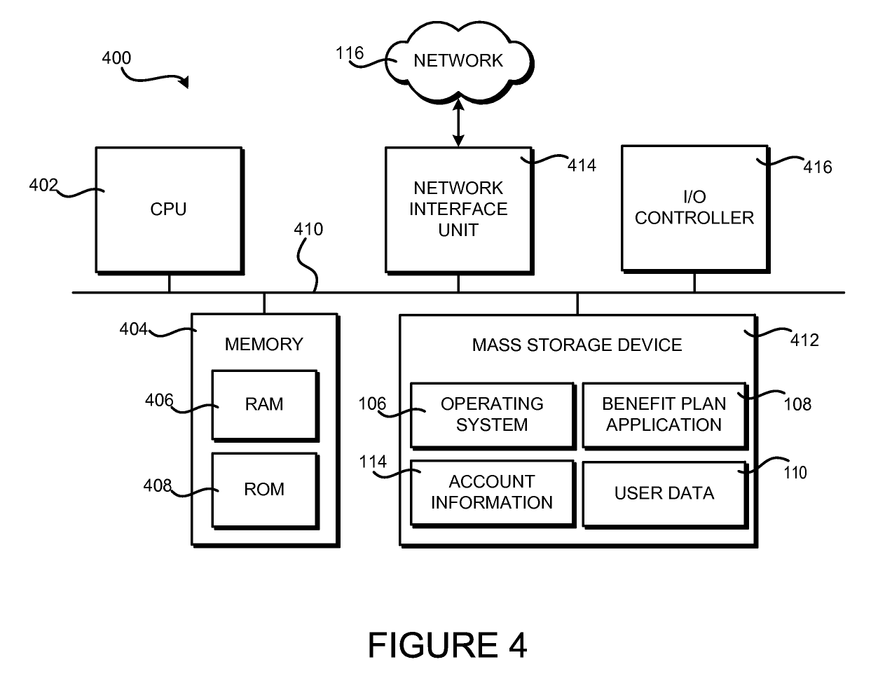

Various aspects of the user device 102 and/or the plan implementation device 104 are illustrated and described below, particularly with reference to FIG. 4. The functionality of the user device 102 and/or the plan implementation device 104 may be provided by a tablet or slate computing device, a smartphone, or a personal computer. The functionality, however, can be provided by additional and/or alternative devices. It should be understood that these examples are illustrative, and should not be construed as being limiting in any way.

The plan implementation device 104 can be configured to execute an operating system 106 and a benefit plan application 108. The operating system 106 is a computer program for controlling the operation of the plan implementation device 104. The benefit plan application 108 is an executable program configured to execute on top of the operating system 106 to provide various functions. The benefit plan application 108 can be configured to receive user data 110 from the user device 102, to execute various operations with respect to the user data 110, or to render various views of the user data 110 in a user interface.

The user data 110 may be stored in a data store 112 of the plan implementation device 104 or may be stored in an account information data store 114. The account information data store 114 may be a data store accessed through a network 116. In some organizations, the plan implementation device 104 may be a computing device used by an individual financial specialist. For various reasons, the user data 110 may be stored on the local, plan implementation device 104 and/or the remote, possibly more secure, account information data store 114. The presently disclosed subject matter is not limited to any particular configuration.

The benefit plan application 108 may be configured to provide a retirement plan. An employer may make a commitment to contribute a fixed percentage of payroll each payroll cycle. An actuarial basis determined by actuarial module 116A may be used to determine liabilities in the plan. An actuary, or other suitable technology, may determine the benefit which is the funded portion of the retirement plan using the fixed percentage. In some examples, a retirement plan executed according to various technologies described herein can guarantee a benefit of half of the funded portion as reduced by a margin. Various aspects of the plan may set a fiduciary standard for investment returns.

In some examples, a failure to meet this fiduciary standard might be the way an employer is forced to contribute additional assets. A retirement plan executed according to various technologies described herein defines the method to value the liability for the plan with a mechanism to update the assumptions as needed. In the event the plan is overfunded by 100% or more, in some examples, the plan may pay double the guaranteed benefit. In some examples, no additional payments may be made when the funded status declines to a surplus, such as a 75% surplus.

In the event the plan is overfunded by 150% or more (or some other specified overfunding level), an entity implementing the plan may either enhance benefits or reduce contributions, or both. Funded status may be determined at specified times (e.g. periodically), and benefit payments can be modified at specified times (e.g., periodically). Employer contribution may be a mandated amount. It should be understood that any percentages or amounts described herein are for purposes of illustration only and are not an attempt to limit the scope of the presently disclosed subject matter to those amounts or percentages.

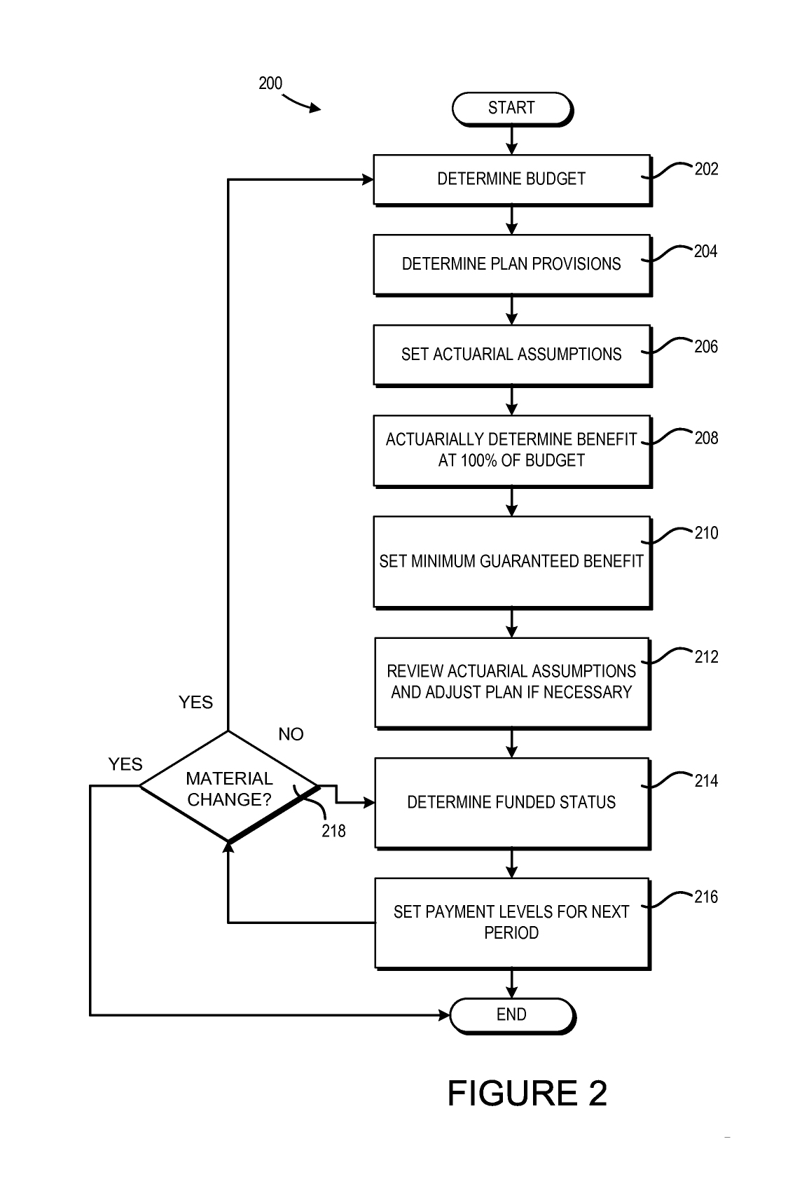

FIG. 2 is a flow diagram showing aspects of a method 200 for providing a funding-adjusted guaranteed benefit in a retirement plan, in accordance with some embodiments. It should be understood that the operations of the method 200 are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated method 200 can be ended at any time and need not be performed in its entirety. Some or all operations of the method 200, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

Only for purposes of illustrating and describing the technologies of the present disclosure, the method 200 disclosed herein is described as being performed by the user device 102 in conjunction with the plan implementation device 104 via execution of computer executable instructions such as, for example, the benefit plan application 108. Additionally, devices other than, or in addition to, the user device 102 and/or the plan implementation device 104 can be configured to provide the functionality described herein via execution of computer executable instructions. As such, it should be understood that the described configuration is illustrative, and should not be construed as being limiting in any way.

The method 200 may begin at operation 202, where a budget is determined. A retirement plan according to various aspects disclosed herein may be designed to focus on having a fixed cost (amount). A benefit may be derived from what a fixed amount can fund. A fixed amount can be a percentage of payroll, or a flat dollar amount per employee. For example if there are 100 employees and the fixed amount is $1,000 per employee, the budget may be $100,000. If a fixed percentage of payroll was chosen, such as 8%, and payroll was $2,000,000 annually, the budget may start at $160,000.

The method 200 may proceed to operation 202, where plan provisions are determined. The plan provisions may be the specific structure of the benefits to be provided. The plan provisions may include, but are not limited to, the following possible considerations: Early Retirement. Is it allowed? What age can a person early retire at? Is the benefit reduced? Can a person become eligible for an unreduced or subsidized early retirement benefit?; Normal Retirement. The age the benefit is unreduced regardless of service; Death Benefit. What participants receive if they die; Disability Benefit. What participants receive if they are disabled; Vesting provisions. How and when the benefits vest; Optional Forms. What forms of benefit the participant can receive, examples of which include, but are not limited to, life only, or 50% joint and survivor. The benefit may be reduced to pay for the insurance; Actuarial Equivalence. The mathematical basis for calculating lump sums and optional forms; Lump Sum benefits (if any); and Benefit Type—percent of pay, dollar per month, offset.

The method 200 may proceed to operation 206, where actuarial assumptions are set. Actuarial assumptions may include, but are not limited to, Mortality; Discount Rate; Turnover; Retirement; Salary increases if applicable; and Inflation if applicable. In some implementations, the assumptions may need to have a stochastic probability of success over 10 year periods in excess of 50%. The actuarial assumptions may be used to determine risks associated with the implementation of a plan. The risk may be used to determine the various (over)funding percentages and the accompanying benefit payouts at the various (over)funding percentages.

The method 200 may proceed to operation 208, wherein actuarially a benefit is determined at 100% of budget. The plan provisions and actuarial assumptions are used to back into what benefit formula is funded by the budgeted expenditures. The actuarial assumptions, or other provisions of the plan, may not be based on any accounting or IRS mandated valuation methodology. Some methods to determine this amount are entry age normal (level dollar or level percentage of pay) or projected unit credit.

The method 200 may proceed to operation 210, where a minimum guaranteed benefit is set. In some examples, the minimum guaranteed benefit may be less than 50% (or other percentage) of the actuarially determined benefit. A minimum guaranteed benefit of a percentage of the actuarially determined benefit may hedge against retirement plan volatility. This minimum benefit is the amount that is guaranteed to the participants. In some implementations, the actuarially determined liability may be based on the above actuarial assumptions and may be independent from accounting or legal funding requirements. The employer may set a goal for benefit security and then may back into the percentage reduction. For example, at 50% fifty percent of the time, the plan may fail to pay out double the guaranteed benefit. At 40% to around 97% of the time, the plan may pay out double the guaranteed benefit.

The method 200 may continue to operation 212, where actuarial assumptions are reviewed and the plan is adjusted if necessary. From time to time appropriate assumptions may change due to changes in turnover, staffing, etc. Changes may be made to the assumptions because these and other changes may change the liabilities (risks) associated with the retirement plan. The changes may be regularly reviewed to see that the assumptions remain appropriate. In some implementations, management and an enrolled actuary may need to be involved in operation 212.

The method 200 may continue to operation 214, where the funded status is determined. An actuarial valuation of the plan liabilities may be performed based upon the actuarial assumptions and the plan provisions. The funded status may be the market value of assets (no asset smoothing) divided by the actuarial accrued liability of the guaranteed benefit.

The method 200 may continue to operation 216, where payment levels are set for a next period. Based on the funded status of the plan, a benefit payment enhancement or change may be set if any for the following period. In some implementations, there may be a January 1 measurement date, and the benefit payments would be July-June. The method 200 may thereafter end or may continue to operation 218.

In operation 218, a determination is made as to whether or not a material change has been made to one or more mortality tables underlying Actuarial assumptions. In some examples, a mortality table is a table which shows, for each age, what the probability is that a person of that age will die before his or her next birthday. Changes to data in the mortality table may be significant enough, or “material,” that changes to a retirement plan may need to be made in order to provide for a sustainable retirement plan. For example, a cure for a common cancer may increase significantly, or materially change, the life expectancy of a certain portions of the population. The presently disclosed subject matter is not limited to any degree to which data in a mortality table may change to qualify as “material.”

If at operation 218, a determination is made that a material change is not present in the mortality tables used to implement a particular retirement plan, the method 200 may continue to operation 214 in the manner described above. If at operation 218, a determination is made that a material change is present in the mortality tables used to implement a particular retirement plan, in the example illustrated in FIG. 2, the method 200 may continue to operation 202 or end. Although not limited to any particular reason, if the material change is significant enough that the retirement plan cannot be adjusted to provide for an acceptable level of return, the retirement plan may be suspended or canceled. If the material change is at a level where the retirement plan can be adjusted, the method 200 may continue to operation 202, where the budget is determined and the method 200 is continued.

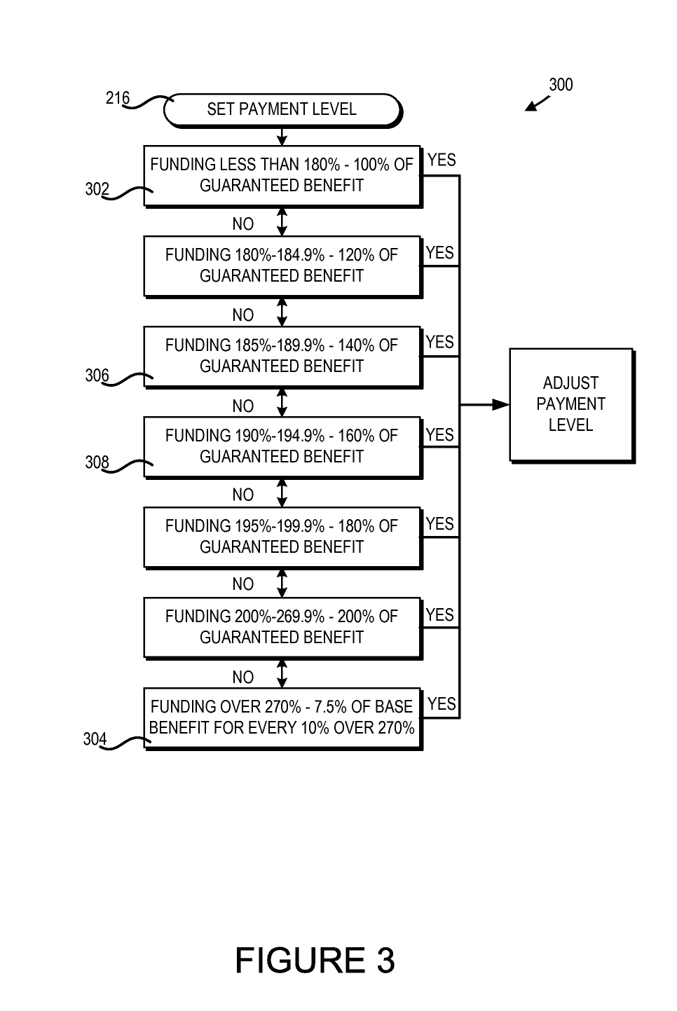

FIG. 3 is a diagram showing aspects of adjusting a payment level, in accordance with some embodiments. It should be noted that FIG. 3 is merely exemplary, as retirement plan funding and benefit percentages may be different based on the risks associated with various aspects of the retirement plan. In FIG. 3, various funding levels for an exemplary benefit plan are described. The minimum guaranteed benefit 302 may be all that was paid until the retirement plan was at least 180% overfunded.

In some examples, a practical consideration may be that a goal for the plan is to pay double the guaranteed benefit and to cut back the payments quickly so the plan will recover and not be underfunded to pay the bonus benefits. An example is that the benefit may be cut back by 50% at 180% funding. The lower funding percentage goes before cutting back the benefit, the less likely it is that the benefit will recover completely or at all. A lower percentage also increases the likelihood that the plan sponsor may have to fund in excess of the fixed contribution amount. The goal on the additional payments at 270% funded is to retain the same level of benefit security on any benefit increase.

From the minimum guaranteed benefit 302 to the top tier benefit 304, the benefit paid to the beneficiary may be adjusted based on the percentage of overfunding from the minimum guaranteed benefit 302. For example, benefit level 306 is a tier at which the beneficiary will receive 140% of the guaranteed benefit if the retirement plan is overfunded by 185%-189.9% (from the funding level associated with the minimum guaranteed benefit 302). If the retirement plan overfunding increases to 190%-194.9% of the funding level associated with the minimum guaranteed benefit 302, the retirement plan is at benefit level 308, where the beneficiary will receive 160% of the minimum guaranteed benefit 302.

Likewise, the reverse may be true. If the overfunding percentage decreases from the level associated with benefit level 308 to the level associated with the benefit level 306, the benefit will be adjusted to the amount represented by the tier. Similar percentage adjustments may be performed for the various levels illustrated by way of example in FIG. 3. At the top tier benefit 304, the benefit may be adjusted on a percentage basis. In some examples, the amount of contribution required of the plan provider may be reduced based on the amount of overfunding.

FIG. 4 illustrates an illustrative computer architecture 400 for a device capable of executing the software components described herein for providing a funding-adjusted guaranteed benefit in a retirement plan. Thus, the computer architecture 400 illustrated in FIG. 4 illustrates an architecture for a server computer, mobile phone, a smart phone, a desktop computer, a netbook computer, a tablet computer, and/or a laptop computer. The computer architecture 400 may be utilized to execute any aspects of the technologies presented herein.

The computer architecture 400 illustrated in FIG. 4 includes a central processing unit 402 (“CPU”), a system memory 404, including a random access memory 406 (“RAM”) and a read-only memory (“ROM”) 408, and a system bus 410 that couples the memory 404 to the CPU 402. A basic input/output system containing the basic routines that help to transfer information between elements within the computer architecture 400, such as during startup, is stored in the ROM 408. The computer architecture 400 further includes a mass storage device 412 for storing the operating system 106 and one or more application programs including, but not limited to, the benefit plan application 108. The mass storage device 412 also can be configured to store data such as, for example, the user data 110 or the account information 114.

The mass storage device 412 is connected to the CPU 402 through a mass storage controller (not shown) connected to the bus 410. The mass storage device 412 and its associated computer-readable media provide non-volatile storage for the computer architecture 400. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 400. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 400 may operate in a networked environment using logical connections to remote computers through a network such as the network 116. The computer architecture 400 may connect to the network 116 through a network interface unit 414 connected to the bus 410. It should be appreciated that the network interface unit 414 also may be utilized to connect to other types of networks and remote computer systems such as, for example, the plan implementation device 104 and/or the user device 102. The computer architecture 400 also may include an input/output controller 416 for receiving and processing input from a number of other devices, including a keyboard, mouse, or electronic stylus (not shown in FIG. 4). Similarly, the input/output controller 416 may provide output to a display screen, a printer, or other type of output device (also not shown in FIG. 4).

It should be appreciated that the software components described herein may, when loaded into the CPU 402 and executed, transform the CPU 402 and the overall computer architecture 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine, in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 400 in order to store and execute the software components presented herein. It also should be appreciated that the computer architecture 400 may include other types of computing devices, including hand-held computers, embedded computer systems, personal digital assistants, and other types of computing devices known to those skilled in the art. It is also contemplated that the computer architecture 400 may not include all of the components shown in FIG. 4, may include other components that are not explicitly shown in FIG. 4, or may utilize an architecture completely different than that shown in FIG. 4.

Although the subject matter presented herein has been described in language specific to computer structural features, methodological and transformative acts, specific computing machinery, and computer readable media, it is to be understood that the presently disclosed subject matter defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the presently disclosed subject matter, which is set forth in the following claims.

What is claimed is:

1. A computerized method for a funding-adjusted guaranteed benefit in a retirement plan, the method comprising:
determining a budget;
determining plan provisions;
setting actuarial assumptions;
determining actuarially a benefit at one hundred percent of the budget;
setting a minimum guaranteed benefit that is guaranteed to the participants; and
setting a plurality of payment levels for a current period.

2. The computerized method of claim 1, wherein the budget is based on a fixed cost.

3. The computerized method of claim 1, wherein the budget is based on a percentage of payroll.

4. The computerized method of claim 1, wherein the budget is based on a flat dollar amount per employee.

5. The computerized method of claim 1, wherein the plan provisions comprise early retirement.

6. The computerized method of claim 1, wherein the plan provisions comprise death benefits.

7. The computerized method of claim 1, wherein the plan provisions comprise disability benefits.

8. The computerized method of claim 1, wherein the actuarial assumptions comprise mortality, discount rate, turnover, retirement, salary increases, and inflation if applicable.

9. The computerized method of claim 1, wherein the actuarial assumptions are configured to have a stochastic probability of success over a predetermined period in excess of fifty percent.

10. The computerized method of claim 1, wherein the actuarial assumptions may be used to determine a risk associated with the implementation of the retirement plan.

11. The computerized method of claim 10, wherein the risk may be used to determine a plurality of overfunding percentages and an accompanying benefit payout at each of the plurality of overfunding percentages.

12. The computerized method of claim 1, wherein the minimum guaranteed benefit may be less than fifty percent of the determined benefit.

13. The computerized method of claim 1, wherein the minimum guaranteed benefit may hedge against volatility of the retirement plan.

14. The computerized method of claim 1, further comprising reviewing actuarial assumptions and adjusting the retirement plan.

15. The computerized method of claim 14, further comprising determining a status of funding of the retirement plan.

16. The computerized method of claim 15, further comprising setting payment levels for a next period based on the status of funding of the retirement plan.

17. The computerized method of claim 1, wherein the plurality of payment levels for the current period comprises:
paying the minimum guaranteed benefit until the retirement plan is up to at least one hundred and eighty percent overfunded;
paying one hundred and twenty percent of the minimum guaranteed benefit if the retirement plan is overfunded from greater than one hundred and eighty percent up to one hundred and eighty five percent;
paying one hundred and forty percent of the minimum guaranteed benefit if the retirement plan is overfunded from one hundred and eighty five percent up to one hundred and eighty nine percent;
paying one hundred and sixty percent of the minimum guaranteed benefit if the retirement plan is overfunded from one hundred and ninety percent up to one hundred and ninety five percent;
paying one hundred and eighty percent of the minimum guaranteed benefit if the retirement plan is overfunded from one hundred and ninety five percent up to one hundred and ninety nine percent; and
paying two hundred percent of the minimum guaranteed benefit if the retirement plan is overfunded from two hundred percent up to two hundred and sixty nine percent.

18. The computerized method of claim 1, further comprising paying a percentage of the minimum guaranteed benefit for a certain percentage of funding of the retirement plan over two hundred and seventy percent.

19. A computer-readable storage medium having computer-executable instructions stored thereupon which, when executed by one or more processors, cause the one or more processors to:
determine a budget;
determine plan provisions;
set actuarial assumptions;
determine actuarially a benefit at one hundred percent of the budget;
set a minimum guaranteed benefit that is guaranteed to the participants;
set a plurality of payment levels for a current period;
review actuarial assumptions;
adjust the retirement plan;
determine a status of funding; and
set a plurality of payment levels for a next period.

20. A computing system, the computing system comprising:
a processor; and
a computer-readable storage medium having computer-executable instructions stored thereupon which, when executed on the processor, cause the processor to
determine a budget;
determine plan provisions;
set actuarial assumptions;
determine actuarially a benefit at one hundred percent of the budget;
set a minimum guaranteed benefit that is guaranteed to the participants;
set a plurality of payment levels for a current period;
review actuarial assumptions;
adjust the retirement plan;
determine a status of funding; and
set a plurality of payment levels for a next period.
